(19) United States
(12) Patent Application Publication
(10) Pub. No.: US 2025/0373926 A1
(43) Pub. Date: Dec. 4, 2025

(54) TECHNIQUES FOR SELECTING OBJECTS

(71) Applicant: Apple Inc., Cupertino, CA (US)

(72) Inventors: Onur E. TACKIN, Saratoga, CA (US); Dhruv SAMANT, San Francisco, CA (US); Mahmut DEMIR, Pleasanton, CA (US); Stephen C. SCHWEIZER, Mountain View, CA (US)

(21) Appl. No.: 19/171,649

(22) Filed: Apr. 7, 2025

Related U.S. Application Data
(60) Provisional application No. 63/653,588, filed on May 30, 2024.

(51) Int. Cl. H04N 23/611; G06F 3/01; G06F 3/16

(52) U.S. Cl. CPC H04N 23/611; G06F 3/013; G06F 3/16

(57) ABSTRACT

The present disclosure generally relates to selecting objects. Some techniques are for selecting people in accordance with some embodiments. Other techniques are for resetting memory of a subject selection model in accordance with some embodiments.

### CROSS-REFERENCE TO RELATED APPLICATIONS

The present application claims priority to U.S. Provisional Patent Application Ser. No. 63/653,588, entitled “TECHNIQUES FOR SELECTING OBJECTS” filed May 30, 2024, which is hereby incorporated by reference in its entirety for all purposes.

### BACKGROUND

Voice assistants and smart cameras face challenges in environments with multiple users. Voice assistants may struggle to detect and prioritize commands from the correct individual, while cameras can have difficulty tracking specific people in crowded settings or figuring out who is more important in a scene. Improved techniques are needed to enhance user detection and selection in these scenarios.

### SUMMARY

This disclosure provides more effective and/or efficient techniques for selecting objects using examples of framing a selected object for capture. It should be recognized that other applications of selecting an object can use techniques described herein. For example, different audio inputs can be selected among multiple audio inputs using techniques described herein. In addition, techniques optionally complement or replace other techniques for selecting objects.

Some techniques are described herein for selecting an object based on a series of rules and a separate machine learning model. Other techniques are described for resetting memory of a machine learning model when an object selected by the machine learning model differs from an object selected by a series of rules.

In some embodiments, a method that is performed at a computer system that is in communication with one or more input devices is described. In some embodiments, the method comprises: detecting, via the one or more input devices, one or more subjects in an environment; and in response to detecting the one or more subjects in the environment: in accordance with a determination that the one or more subjects includes a plurality of subjects, that the plurality of subjects satisfy a first set of one or more criteria, and that a first subject of the plurality of subjects is selected via a subject selection model, performing a first operation with respect to the first subject without performing an operation with respect to a second subject of the plurality of subjects, wherein the second subject is different from the first subject, and wherein the first set of one or more criteria does not include a criterion based on the subject selection model; in accordance with a determination that the one or more subjects includes the plurality of subjects, that the plurality of subjects satisfy the first set of one or more criteria, and that the second subject is selected via the subject selection model, performing a second operation with respect to the second subject without performing an operation with respect to the first subject; and in accordance with a determination that the one or more subjects includes a third subject and that the third subject satisfies the first set of one or more criteria, performing a third operation with respect to the third subject.

In some embodiments, a non-transitory computer-readable storage medium storing one or more programs configured to be executed by one or more processors of a computer system that is in communication with one or more input devices is described. In some embodiments, the one or more programs includes instructions for: detecting, via the one or more input devices, one or more subjects in an environment; and in response to detecting the one or more subjects in the environment: in accordance with a determination that the one or more subjects includes a plurality of subjects, that the plurality of subjects satisfy a first set of one or more criteria, and that a first subject of the plurality of subjects is selected via a subject selection model, performing a first operation with respect to the first subject without performing an operation with respect to a second subject of the plurality of subjects, wherein the second subject is different from the first subject, and wherein the first set of one or more criteria does not include a criterion based on the subject selection model; in accordance with a determination that the one or more subjects includes the plurality of subjects, that the plurality of subjects satisfy the first set of one or more criteria, and that the second subject is selected via the subject selection model, performing a second operation with respect to the second subject without performing an operation with respect to the first subject; and in accordance with a determination that the one or more subjects includes a third subject and that the third subject satisfies the first set of one or more criteria, performing a third operation with respect to the third subject.

In some embodiments, a transitory computer-readable storage medium storing one or more programs configured to be executed by one or more processors of a computer system that is in communication with one or more input devices is described. In some embodiments, the one or more programs includes instructions for: detecting, via the one or more input devices, one or more subjects in an environment; and in response to detecting the one or more subjects in the environment: in accordance with a determination that the one or more subjects includes a plurality of subjects, that the plurality of subjects satisfy a first set of one or more criteria, and that a first subject of the plurality of subjects is selected via a subject selection model, performing a first operation with respect to the first subject without performing an operation with respect to a second subject of the plurality of subjects, wherein the second subject is different from the first subject, and wherein the first set of one or more criteria does not include a criterion based on the subject selection model; in accordance with a determination that the one or more subjects includes the plurality of subjects, that the plurality of subjects satisfy the first set of one or more criteria, and that the second subject is selected via the subject selection model, performing a second operation with respect to the second subject without performing an operation with respect to the first subject; and in accordance with a determination that the one or more subjects includes a third subject and that the third subject satisfies the first set of one or more criteria, performing a third operation with respect to the third subject.

In some embodiments, a computer system configured to communicate with one or more input devices is described. In some embodiments, the computer system comprises one or more processors and memory storing one or more programs configured to be executed by the one or more processors. In some embodiments, the one or more programs includes instructions for: detecting, via the one or more input devices, one or more subjects in an environment; and in response to detecting the one or more subjects in the environment: in accordance with a determination that the one or more subjects includes a plurality of subjects, that the plurality of subjects satisfy a first set of one or more criteria, and that a first subject of the plurality of subjects is selected via a subject selection model, performing a first operation with respect to the first subject without performing an operation with respect to a second subject of the plurality of subjects, wherein the second subject is different from the first subject, and wherein the first set of one or more criteria does not include a criterion based on the subject selection model; in accordance with a determination that the one or more subjects includes the plurality of subjects, that the plurality of subjects satisfy the first set of one or more criteria, and that the second subject is selected via the subject selection model, performing a second operation with respect to the second subject without performing an operation with respect to the first subject; and in accordance with a determination that the one or more subjects includes a third subject and that the third subject satisfies the first set of one or more criteria, performing a third operation with respect to the third subject.

In some embodiments, a computer system configured to communicate with one or more input devices is described. In some embodiments, the computer system comprises means for performing each of the following steps: detecting, via the one or more input devices, one or more subjects in an environment; and in response to detecting the one or more subjects in the environment: in accordance with a determination that the one or more subjects includes a plurality of subjects, that the plurality of subjects satisfy a first set of one or more criteria, and that a first subject of the plurality of subjects is selected via a subject selection model, performing a first operation with respect to the first subject without performing an operation with respect to a second subject of the plurality of subjects, wherein the second subject is different from the first subject, and wherein the first set of one or more criteria does not include a criterion based on the subject selection model; in accordance with a determination that the one or more subjects includes the plurality of subjects, that the plurality of subjects satisfy the first set of one or more criteria, and that the second subject is selected via the subject selection model, performing a second operation with respect to the second subject without performing an operation with respect to the first subject; and in accordance with a determination that the one or more subjects includes a third subject and that the third subject satisfies the first set of one or more criteria, performing a third operation with respect to the third subject.

In some embodiments, a computer program product is described. In some embodiments, the computer program product comprises one or more programs configured to be executed by one or more processors of a computer system that is in communication with one or more input devices. In some embodiments, the one or more programs include instructions for: detecting, via the one or more input devices, one or more subjects in an environment; and in response to detecting the one or more subjects in the environment: in accordance with a determination that the one or more subjects includes a plurality of subjects, that the plurality of subjects satisfy a first set of one or more criteria, and that a first subject of the plurality of subjects is selected via a subject selection model, performing a first operation with respect to the first subject without performing an operation with respect to a second subject of the plurality of subjects, wherein the second subject is different from the first subject, and wherein the first set of one or more criteria does not include a criterion based on the subject selection model; in accordance with a determination that the one or more subjects includes the plurality of subjects, that the plurality of subjects satisfy the first set of one or more criteria, and that the second subject is selected via the subject selection model, performing a second operation with respect to the second subject without performing an operation with respect to the first subject; and in accordance with a determination that the one or more subjects includes a third subject and that the third subject satisfies the first set of one or more criteria, performing a third operation with respect to the third subject.

In some embodiments, a method that is performed at a computer system is described. In some embodiments, the method comprises: receiving, via a subject selection model, an identification of a first subject; receiving, via a first set of one or more heuristics, an identification of a second subject; and after receiving the identification of the first subject and the identification of the second subject: in accordance with a determination that the first subject is different from the second subject, resetting memory of the subject selection model; and in accordance with a determination that the first subject is the second subject, forgoing resetting the memory of the subject selection model.

In some embodiments, a non-transitory computer-readable storage medium storing one or more programs configured to be executed by one or more processors of a computer system is described. In some embodiments, the one or more programs includes instructions for: receiving, via a subject selection model, an identification of a first subject; receiving, via a first set of one or more heuristics, an identification of a second subject; and after receiving the identification of the first subject and the identification of the second subject: in accordance with a determination that the first subject is different from the second subject, resetting memory of the subject selection model; and in accordance with a determination that the first subject is the second subject, forgoing resetting the memory of the subject selection model.

In some embodiments, a transitory computer-readable storage medium storing one or more programs configured to be executed by one or more processors of a computer system is described. In some embodiments, the one or more programs includes instructions for: receiving, via a subject selection model, an identification of a first subject; receiving, via a first set of one or more heuristics, an identification of a second subject; and after receiving the identification of the first subject and the identification of the second subject: in accordance with a determination that the first subject is different from the second subject, resetting memory of the subject selection model; and in accordance with a determination that the first subject is the second subject, forgoing resetting the memory of the subject selection model.

In some embodiments, a computer system is described. In some embodiments, the computer system comprises one or more processors and memory storing one or more programs configured to be executed by the one or more processors. In some embodiments, the one or more programs includes instructions for: receiving, via a subject selection model, an identification of a first subject; receiving, via a first set of one or more heuristics, an identification of a second subject; and after receiving the identification of the first subject and the identification of the second subject: in accordance with a determination that the first subject is different from the second subject, resetting memory of the subject selection model; and in accordance with a determination that the first subject is the second subject, forgoing resetting the memory of the subject selection model.

In some embodiments, a computer system is described. In some embodiments, the computer system comprises means for performing each of the following steps: receiving, via a subject selection model, an identification of a first subject; receiving, via a first set of one or more heuristics, an identification of a second subject; and after receiving the identification of the first subject and the identification of the second subject: in accordance with a determination that the first subject is different from the second subject, resetting memory of the subject selection model; and in accordance with a determination that the first subject is the second subject, forgoing resetting the memory of the subject selection model.

In some embodiments, a computer program product is described. In some embodiments, the computer program product comprises one or more programs configured to be executed by one or more processors of a computer system. In some embodiments, the one or more programs include instructions for: receiving, via a subject selection model, an identification of a first subject; receiving, via a first set of one or more heuristics, an identification of a second subject; and after receiving the identification of the first subject and the identification of the second subject: in accordance with a determination that the first subject is different from the second subject, resetting memory of the subject selection model; and in accordance with a determination that the first subject is the second subject, forgoing resetting the memory of the subject selection model.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating a compute system in accordance with some embodiments.

FIG. 1B is a flow diagram illustrating a process for an application in accordance with some embodiments.

FIG. 1C is a flow diagram illustrating another process for an application in accordance with some embodiments.

FIG. 1D is a block diagram illustrating a device in accordance with some embodiments.

FIG. 2 is a block diagram illustrating a device with interconnected subsystems in accordance with some embodiments.

FIG. 3 illustrates exemplary user interfaces for framing selected objects in accordance with some embodiments.

FIG. 4 illustrates exemplary user interfaces for selecting objects in accordance with some embodiments.

FIG. 5 is a flow diagram illustrating a process for selecting subjects in accordance with some embodiments.

FIG. 6 is a flow diagram illustrating a process for resetting memory of a subject selection model in accordance with some embodiments.

### DETAILED DESCRIPTION

The following description sets forth exemplary processes, parameters, and the like. It should be recognized, however, that such description is not intended as a limitation on the scope of the present disclosure but is instead provided as a description of exemplary embodiments.

Processes described herein can include one or more steps that are contingent upon one or more conditions being satisfied. It should be understood that a process can occur over multiple iterations of the same process with different steps of the process being satisfied in different iterations. For example, if a process requires performing a first step upon a determination that a set of one or more criteria is met and a second step upon a determination that the set of one or more criteria is not met, a person of ordinary skill in the art would appreciate that the steps of the process are repeated until both conditions, in no particular order, are satisfied. Thus, a process described with steps that are contingent upon a condition being satisfied can be rewritten as a process that is repeated until each of the conditions described in the process are satisfied. This, however, is not required of system or computer readable medium claims where the system or computer readable medium claims include instructions for performing one or more steps that are contingent upon one or more conditions being satisfied. Because the instructions for the system or computer readable medium claims are stored in one or more processors and/or at one or more memory locations, the system or computer readable medium claims include logic that can determine whether the one or more conditions have been satisfied without explicitly repeating steps of a process until all of the conditions upon which steps in the process are contingent have been satisfied. A person having ordinary skill in the art would also understand that, similar to a process with contingent steps, a system or computer readable storage medium can repeat the steps of a process as many times as needed to ensure that all of the contingent steps have been performed.

Although the following description uses terms “first,” “second,” etc. to describe various elements, these elements should not be limited by the terms. In some embodiments, these terms are used to distinguish one element from another. For example, a first subsystem could be termed a second subsystem, and, similarly, a second subsystem device or a subsystem device could be termed a first subsystem device, without departing from the scope of the various described embodiments. In some embodiments, the first subsystem and the second subsystem are two separate references to the same subsystem. In some embodiments, the first subsystem and the second subsystem are both subsystems, but they are not the same subsystem or the same type of subsystem.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

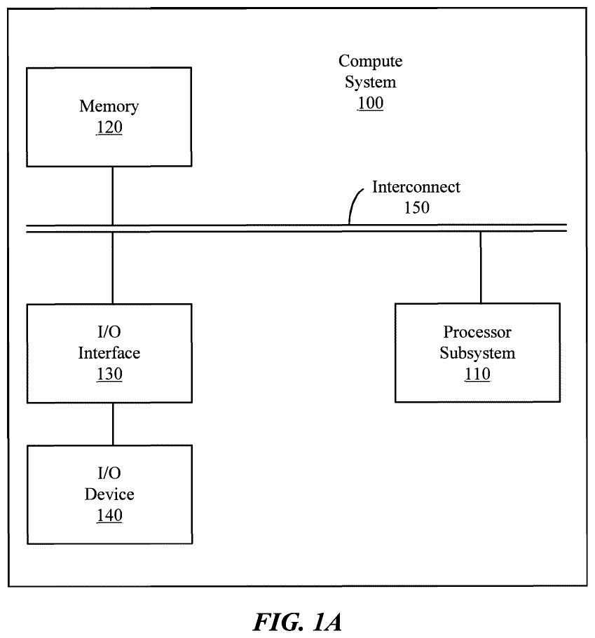

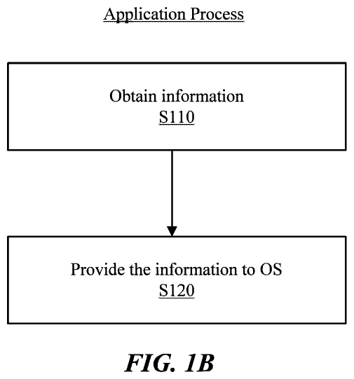

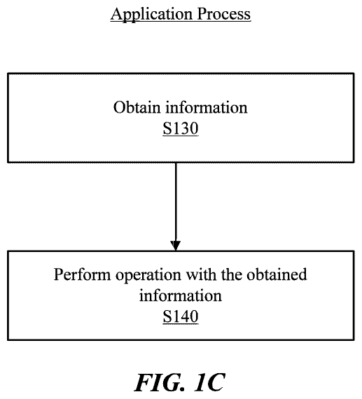

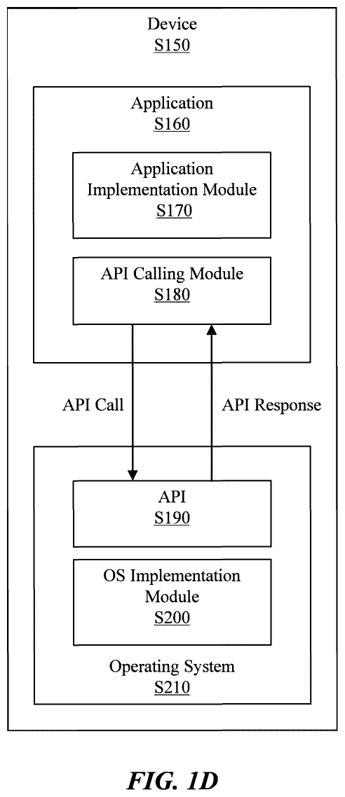

Turning to FIG. 1A, a block diagram of compute system 100 is illustrated. Compute system 100 is a non-limiting example of a compute system that can be used to perform functionality described herein. It should be recognized that other computer architectures of a compute system can be used to perform functionality described herein.

In the illustrated example, compute system 100 includes processor subsystem 110 communicating with (e.g., wired or wirelessly) memory 120 (e.g., a system memory) and I/O interface 130 via interconnect 150 (e.g., a system bus, one or more memory locations, or other communication channel for connecting multiple components of compute system 100). In addition, I/O interface 130 is communicating with (e.g., wired or wirelessly) to I/O device 140. In some embodiments, I/O interface 130 is included with I/O device 140 such that the two are a single component. It should be recognized that there can be one or more I/O interfaces, with each I/O interface communicating with one or more I/O devices. In some embodiments, multiple instances of processor subsystem 110 can be communicating via interconnect 150.

Compute system 100 can be any of various types of devices, including, but not limited to, a system on a chip, a server system, a personal computer system (e.g., a smartphone, a smartwatch, a wearable device, a tablet, a laptop computer, and/or a desktop computer), a sensor, or the like. In some embodiments, compute system 100 is included or communicating with a physical component for the purpose of modifying the physical component in response to an instruction. In some embodiments, compute system 100 receives an instruction to modify a physical component and, in response to the instruction, causes the physical component to be modified. In some embodiments, the physical component is modified via an actuator, an electric signal, and/or algorithm. Examples of such physical components include an acceleration control, a break, a gear box, a hinge, a motor, a pump, a refrigeration system, a spring, a suspension system, a steering control, a pump, a vacuum system, and/or a valve. In some embodiments, a sensor includes one or more hardware components that detect information about a physical environment in proximity to (e.g., surrounding) the sensor. In some embodiments, a hardware component of a sensor includes a sensing component (e.g., an image sensor or temperature sensor), a transmitting component (e.g., a laser or radio transmitter), a receiving component (e.g., a laser or radio receiver), or any combination thereof. Examples of sensors include an angle sensor, a chemical sensor, a brake pressure sensor, a contact sensor, a non-contact sensor, an electrical sensor, a flow sensor, a force sensor, a gas sensor, a humidity sensor, an image sensor (e.g., a camera sensor, a radar sensor, and/or a LiDAR sensor), an inertial measurement unit, a leak sensor, a level sensor, a light detection and ranging system, a metal sensor, a motion sensor, a particle sensor, a photoelectric sensor, a position sensor (e.g., a global positioning system), a precipitation sensor, a pressure sensor, a proximity sensor, a radio detection and ranging system, a radiation sensor, a speed sensor (e.g., measures the speed of an object), a temperature sensor, a time-of-flight sensor, a torque sensor, and an ultrasonic sensor. In some embodiments, a sensor includes a combination of multiple sensors. In some embodiments, sensor data is captured by fusing data from one sensor with data from one or more other sensors. Although a single compute system is shown in FIG. 1A, compute system 100 can also be implemented as two or more compute systems operating together.

In some embodiments, processor subsystem 110 includes one or more processors or processing units configured to execute program instructions to perform functionality described herein. For example, processor subsystem 110 can execute an operating system, a middleware system, one or more applications, or any combination thereof.

In some embodiments, the operating system manages resources of compute system 100. Examples of types of operating systems covered herein include batch operating systems (e.g., Multiple Virtual Storage (MVS)), time-sharing operating systems (e.g., Unix), distributed operating systems (e.g., Advanced Interactive executive (AIX), network operating systems (e.g., Microsoft Windows Server), and real-time operating systems (e.g., QNX). In some embodiments, the operating system includes various procedures, sets of instructions, software components, and/or drivers for controlling and managing general system tasks (e.g., memory management, storage device control, power management, or the like) and for facilitating communication between various hardware and software components. In some embodiments, the operating system uses a priority-based scheduler that assigns a priority to different tasks that processor subsystem 110 can execute. In such examples, the priority assigned to a task is used to identify a next task to execute. In some embodiments, the priority-based scheduler identifies a next task to execute when a previous task finishes executing. In some embodiments, the highest priority task runs to completion unless another higher priority task is made ready.

In some embodiments, the middleware system provides one or more services and/or capabilities to applications (e.g., the one or more applications running on processor subsystem 110) outside of what the operating system offers (e.g., data management, application services, messaging, authentication, API management, or the like). In some embodiments, the middleware system is designed for a heterogeneous computer cluster to provide hardware abstraction, low-level device control, implementation of commonly used functionality, message-passing between processes, package management, or any combination thereof. Examples of middleware systems include Lightweight Communications and Marshalling (LCM), PX4, Robot Operating System (ROS), and ZeroMQ. In some embodiments, the middleware system represents processes and/or operations using a graph architecture, where processing takes place in nodes that can receive, post, and multiplex sensor data messages, control messages, state messages, planning messages, actuator messages, and other messages. In such examples, the graph architecture can define an application (e.g., an application executing on processor subsystem 110 as described above) such that different operations of the application are included with different nodes in the graph architecture.

In some embodiments, a message sent from a first node in a graph architecture to a second node in the graph architecture is performed using a publish-subscribe model, where the first node publishes data on a channel in which the second node can subscribe. In such examples, the first node can store data in memory (e.g., memory 120 or some local memory of processor subsystem 110) and notify the second node that the data has been stored in the memory. In some embodiments, the first node notifies the second node that the data has been stored in the memory by sending a pointer (e.g., a memory pointer, such as an identification of a memory location) to the second node so that the second node can access the data from where the first node stored the data. In some embodiments, the first node would send the data directly to the second node so that the second node would not need to access a memory based on data received from the first node.

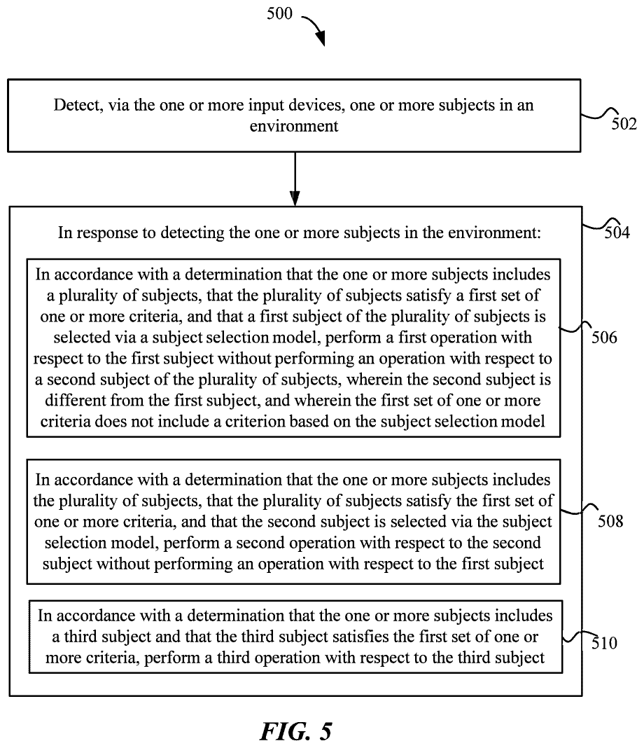

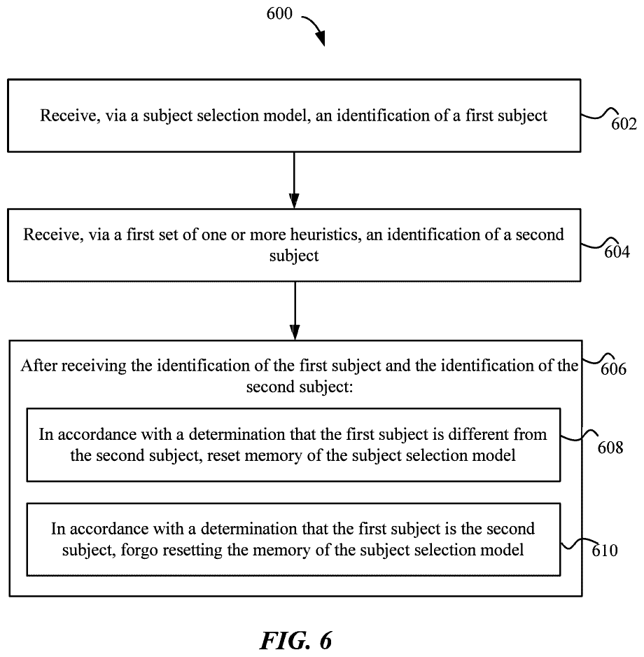

Memory 120 can include a computer readable medium (e.g., non-transitory or transitory computer readable medium) usable to store (e.g., configured to store, assigned to store, and/or that stores) program instructions executable by processor subsystem 110 to cause compute system 100 to perform various operations described herein. For example, memory 120 can store program instructions to implement the functionality associated with processes 500 and 600 (FIGS. 5 and 6) described below.

Memory 120 can be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, or the like), read only memory (PROM, EEPROM, or the like), or the like. Memory in compute system 100 is not limited to primary storage such as memory 120. Compute system 100 can also include other forms of storage such as cache memory in processor subsystem 110 and secondary storage on I/O device 140 (e.g., a hard drive, storage array, etc.). In some embodiments, these other forms of storage can also store program instructions executable by processor subsystem 110 to perform operations described herein. In some embodiments, processor subsystem 110 (or each processor within processor subsystem 110) contains a cache or other form of on-board memory.

I/O interface 130 can be any of various types of interfaces configured to communicate with other devices. In some embodiments, I/O interface 130 includes a bridge chip (e.g., Southbridge) from a front-side bus to one or more back-side buses. I/O interface 130 can communicate with one or more I/O devices (e.g., I/O device 140) via one or more corresponding buses or other interfaces. Examples of I/O devices include storage devices (hard drive, optical drive, removable flash drive, storage array, SAN, or their associated controller), network interface devices (e.g., to a local or wide-area network), sensor devices (e.g., camera, radar, LiDAR, ultrasonic sensor, GPS, inertial measurement device, or the like), and auditory or visual output devices (e.g., speaker, light, screen, projector, or the like). In some embodiments, compute system 100 is communicating with a network via a network interface device (e.g., configured to communicate over Wi-Fi, Bluetooth, Ethernet, or the like). In some embodiments, compute system 100 is directly or wired to the network.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

Implementations within the scope of the present disclosure include a computer-readable storage medium that encodes instructions organized as an application (e.g., application S160) that, when executed by one or more processing units, control an electronic device (e.g., device S150) to perform the process of FIG. 1B, the process of FIG. 1C, and/or one or more other processes and/or processes described herein.

It should be recognized that application S160 can be any suitable type of application, including, for example, one or more of: a messaging application, a maps application, a fitness application, a health application, a digital payments application, a media application, and/or a social network application. In some embodiments, application S160 is an application that is pre-installed on device S150 at purchase (e.g., a first party application). In other embodiments, application S160 is an application that is provided to device S150 via an operating system update file (e.g., a first party application or a second party application). In other embodiments, application S160 is an application that is provided via an application store. In some embodiments, the application store can be an application store that is pre-installed on device S150 at purchase (e.g., a first party application store). In other embodiments, the application store is a third-party application store (e.g., an application store that is provided by another application store, downloaded via a network, and/or read from a storage device).

Referring to FIG. 1B, application S160 obtains information (e.g., S110). In some embodiments, the information obtained at S110 includes positional information, time information, notification information, user information, environment information, electronic device state information, weather information, media information, historical information, event information, hardware information, and/or motion information. In some embodiments, in response to and/or after obtaining the information at S110, application S160 provides the information to operating system (e.g., S120).

Referring to FIG. 1C, application S160 obtains information (e.g., S130). In some embodiments, the information obtained at S130 includes positional information, time information, notification information, user information, environment information electronic device state information, weather information, media information, historical information, event information, hardware information and/or motion information. in response to and/or after obtaining the information at S130, application S160 performs an operation with the information (e.g., S140). In some embodiments, the operation performed at S140 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of operating system S210 based on the information.

In some embodiments, one or more steps of the process of FIG. 1B and/or the process of FIG. 1C is performed in response to a trigger. In some embodiments, the trigger includes detection of an event, a notification received from operating system S210, a user input, and/or a response to a call to an API provided by operating system S210.

In some embodiments, the instructions of application S160, when executed, control device S150 to perform the process of FIG. 1B and/or the process of FIG. 1C by calling an application programming interface (API) (e.g., API S190) provided by operating system S210. In some embodiments, application S160 performs at least a portion of the process of FIG. 1B and/or the process of FIG. 1C without calling API S190.

In some embodiments, one or more steps of the process of FIG. 1B and/or the process of FIG. 1C includes calling an API (e.g., API S190) using one or more parameters defined by the API. In some embodiments, the one or more parameters include a constant, a key, a data structure, an object, an object class, a variable, a data type, a pointer, an array, a list or a pointer to a function or a process, and/or another way to reference a data or other item to be passed via the API.

Referring to FIG. 1D, device S150 is illustrated. In some embodiments, device S150 is a personal computing device, a smart phone, a smart watch, a fitness tracker, a head mounted display (HMD) device, a media device, a communal device, a speaker, a television, and/or a tablet. As illustrated in FIG. 1D, device S150 includes application S160 and operating system S210. Application S160 includes application implementation module S170 and API calling module S180. Operating system S210 includes API S190 and OS implementation module S200. It should be recognized that device S150, application S160, and/or operating system S210 can include more, fewer, and/or different components than illustrated in FIG. 1D.

In some embodiments, application implementation module S170 includes a set of one or more instructions corresponding to one or more operations performed by application S160. For example, when application S160 is a messaging application, application implementation module S170 can include operations to receive and send messages. In some embodiments, application implementation module S170 communicates with API calling module to communicate with operating system S210 via API S190.

In some embodiments, API S190 is a software module (e.g., a collection of computer-readable instructions) that provides an interface that allows a different module (e.g., API calling module S180) to access and/or use one or more functions, processes, procedures, data structures, classes, and/or other services provided by OS implementation module S200 of operating system S210. For example, API-calling module S180 can access a feature of OS implementation module S200 through one or more API calls or invocations (e.g., embodied by a function or a process call) exposed by API S190 and can pass data and/or control information using one or more parameters via the API calls or invocations. In some embodiments, API S190 allows application S160 to use a service provided by a Software Development Kit (SDK) library. In other embodiments, application S160 incorporates a call to a function or process provided by the SDK library and provided by API S190 or uses data types or objects defined in the SDK library and provided by API S190. In some embodiments, API-calling module S180 makes an API call via API S190 to access and use a feature of OS implementation module S200 that is specified by API S190. In such embodiments, OS implementation module S200 can return a value via API S190 to API-calling module S180 in response to the API call. The value can report to application S160 the capabilities or state of a hardware component of device S150, including those related to aspects such as input capabilities and state, output capabilities and state, processing capability, power state, storage capacity and state, and/or communications capability. In some embodiments, API S190 is implemented in part by firmware, microcode, or other low level logic that executes in part on the hardware component.

In some embodiments, API S190 allows a developer of API-calling module S180 (which can be a third-party developer) to leverage a feature provided by OS implementation module S200. In such embodiments, there can be one or more API-calling modules (e.g., including API-calling module S180) that communicate with OS implementation module S200. In some embodiments, API S190 allows multiple API-calling modules written in different programming languages to communicate with OS implementation module S200 (e.g., API S190 can include features for translating calls and returns between OS implementation module S200 and API-calling module S180) while API S190 is implemented in terms of a specific programming language. In some embodiments, API-calling module S180 calls APIs from different providers such as a set of APIs from an OS provider, another set of APIs from a plug-in provider, and/or another set of APIs from another provider (e.g., the provider of a software library) or creator of the another set of APIs.

Examples of API S190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API. In some embodiments the sensor API is an API for accessing data associated with a sensor of device S150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, OS implementation module S200 is an operating system software module (e.g., a collection of computer-readable instructions) that is constructed to perform an operation in response to receiving an API call via API S190. In some embodiments, OS implementation module S200 is constructed to provide an API response (via API S190) as a result of processing an API call. By way of example, OS implementation module S200 and API-calling module 180 can each be any one of an operating system, a library, a device driver, an API, an application program, or other module. It should be understood that OS implementation module S200 and API-calling module S180 can be the same or different type of module from each other. In some embodiments, OS implementation module S200 is embodied at least in part in firmware, microcode, or other hardware logic.

In some embodiments, OS implementation module S200 returns a value through API S190 in response to an API call from API-calling module S180. While API S190 defines the syntax and result of an API call (e.g., how to invoke the API call and what the API call does), API S190 might not reveal how OS implementation module S200 accomplishes the function specified by the API call. Various API calls are transferred via the one or more application programming interfaces between API-calling module S180 and OS implementation module S200. Transferring the API calls can include issuing, initiating, invoking, calling, receiving, returning, and/or responding to the function calls or messages. In other words, transferring can describe actions by either of API-calling module S180 or OS implementation module S200. In some embodiments, a function call or other invocation of API S190 sends and/or receives one or more parameters through a parameter list or other structure.

In some embodiments, OS implementation module S200 provides more than one API, each providing a different view of or with different aspects of functionality implemented by OS implementation module S200. For example, one API of OS implementation module S200 can provide a first set of functions and can be exposed to third party developers, and another API of OS implementation module S200 can be hidden (e.g., not exposed) and provide a subset of the first set of functions and also provide another set of functions, such as testing or debugging functions which are not in the first set of functions. In some embodiments, OS implementation module S200 calls one or more other components via an underlying API and thus be both an API calling module and an OS implementation module. It should be recognized that OS implementation module S200 can include additional functions, processes, classes, data structures, and/or other features that are not specified through API S190 and are not available to API calling module S180. It should also be recognized that API calling module S180 can be on the same system as OS implementation module S200 or can be located remotely and access OS implementation module S200 using API S190 over a network. In some embodiments, OS implementation module S200, API S190, and/or API-calling module S180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

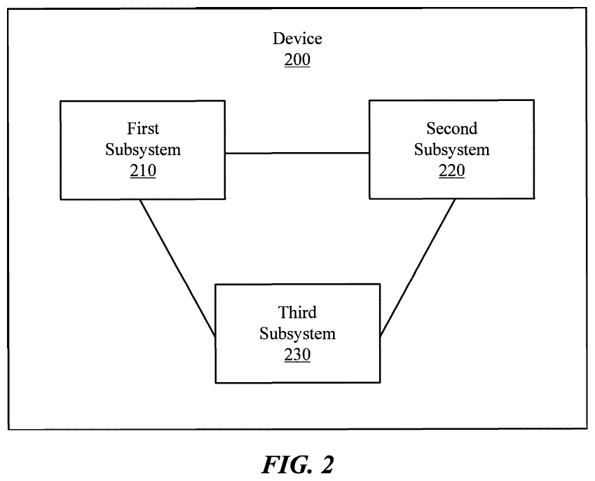

FIG. 2 illustrates a block diagram of device 200 with interconnected subsystems. In the illustrated example, device 200 includes three different subsystems (i.e., first subsystem 210, second subsystem 220, and third subsystem 230) communicating with (e.g., wired or wirelessly) each other, creating a network (e.g., a personal area network, a local area network, a wireless local area network, a metropolitan area network, a wide area network, a storage area network, a virtual private network, an enterprise internal private network, a campus area network, a system area network, and/or a controller area network). An example of a possible computer architecture of a subsystem as included in FIG. 2 is described in FIG. 1A (i.e., compute system 100). Although three subsystems are shown in FIG. 2, device 200 can include more or fewer subsystems.

In some embodiments, some subsystems are not connected to other subsystem (e.g., first subsystem 210 can be connected to second subsystem 220 and third subsystem 230 but second subsystem 220 cannot be connected to third subsystem 230). In some embodiments, some subsystems are connected via one or more wires while other subsystems are wirelessly connected. In some embodiments, messages are set between the first subsystem 210, second subsystem 220, and third subsystem 230, such that when a respective subsystem sends a message the other subsystems receive the message (e.g., via a wire and/or a bus). In some embodiments, one or more subsystems are wirelessly connected to one or more compute systems outside of device 200, such as a server system. In such examples, the subsystem can be configured to communicate wirelessly to the one or more compute systems outside of device 200.

In some embodiments, device 200 includes a housing that fully or partially encloses subsystems 210-230. Examples of device 200 include a home-appliance device (e.g., a refrigerator or an air conditioning system), a robot (e.g., a robotic arm or a robotic vacuum), and a vehicle. In some embodiments, device 200 is configured to navigate (with or without user input) in a physical environment.

In some embodiments, one or more subsystems of device 200 are used to control, manage, and/or receive data from one or more other subsystems of device 200 and/or one or more compute systems remote from device 200. For example, first subsystem 210 and second subsystem 220 can each be a camera that captures images, and third subsystem 230 can use the captured images for decision making. In some embodiments, at least a portion of device 200 functions as a distributed compute system. For example, a task can be split into different portions, where a first portion is executed by first subsystem 210 and a second portion is executed by second subsystem 220.

Attention is now directed towards techniques for selecting one or more objects. Such techniques are described in the context of framing the one or more objects in media. It should be recognized that other applications of selecting objects can be used with techniques described herein. For example, verbal commands can be responded to differently depending on which objects are selected using techniques described herein. In addition, techniques optionally complement or replace other techniques for selecting objects.

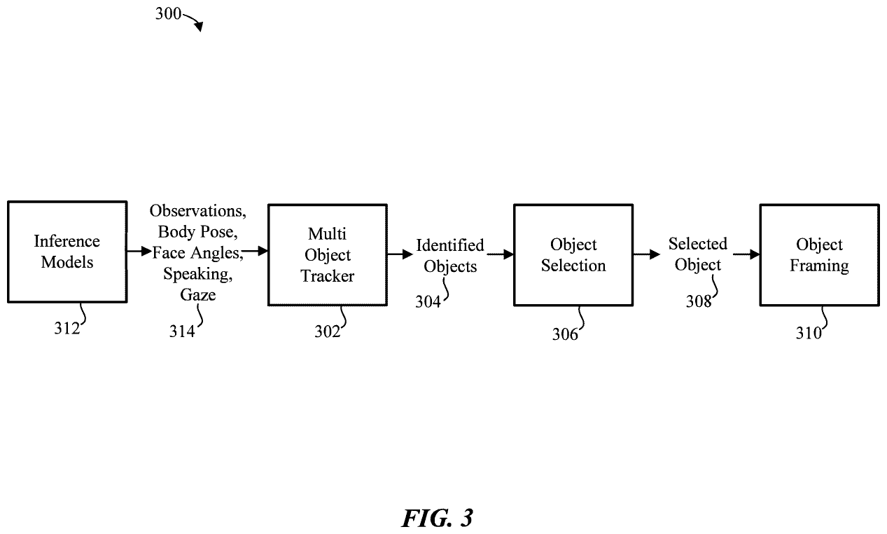

FIG. 3 is a block diagram illustrating a process used to frame one or more objects in accordance with some embodiments. For explanatory purposes, the description below is with respect to framing multiple people who are moving around and/or otherwise interacting within a physical environment. It should be recognized that other types of objects can be framed in addition to and/or instead of people.

In some embodiments, “framing” includes changing how media is captured via one or more cameras such as to highlight or focus on one or more selected objects. For example, framing can include moving, tilting, panning, zooming in, zooming out, cropping, adjusting focus of, and/or changing a set of one or more cameras used for a frame. In one example, the computer system can physically move a movable mount that is attached to the computer system to frame one or more selected objects in a particular manner via the one or more cameras. Effective framing can enhance storytelling, convey meaning, and/or provide context within visual content.

In some embodiments, process 300 includes more, fewer, and/or different components and/or one or more components are in a different order than illustrated in FIG. 3. It should be recognized that each of the modules of process 300 can be performed by the computer system and/or one or more other computer systems separate from the computer system.

As illustrated in FIG. 3, process 300 includes inference models 312 and multi object tracker 302. In some embodiments, multi object tracker 302 captures, via the one or more cameras, media (e.g., video and/or images) and identifies objects within the media and inference models 312 outputs, detected object observations, or in the case of humans: body pose, face angles, if the human is speaking, and/or gaze attributes (e.g., observations, body pose, face angles, speaking, gaze 314) to multi object tracker 302. In some embodiments, multi object tracker 302 identifies attributes of the objects such as features of a person (e.g., the upper torso, lower torso, and/or head). For example, gaze, face orientation, body orientation, distance to the one or more cameras, and/or whether the person is speaking or pointing in a particular direction can be identified by multi object tracker 302. In some embodiments, multi object tracker 302 assigns each object an identification. In such embodiments, multi object tracker 302 associates these attributes such as observations, body pose, face angles, speaking, gaze 314 to objects and can output the identification of each object as identified objects 304. In some embodiments, multi object tracker 302 also outputs the attributes of each object with identified objects 304.

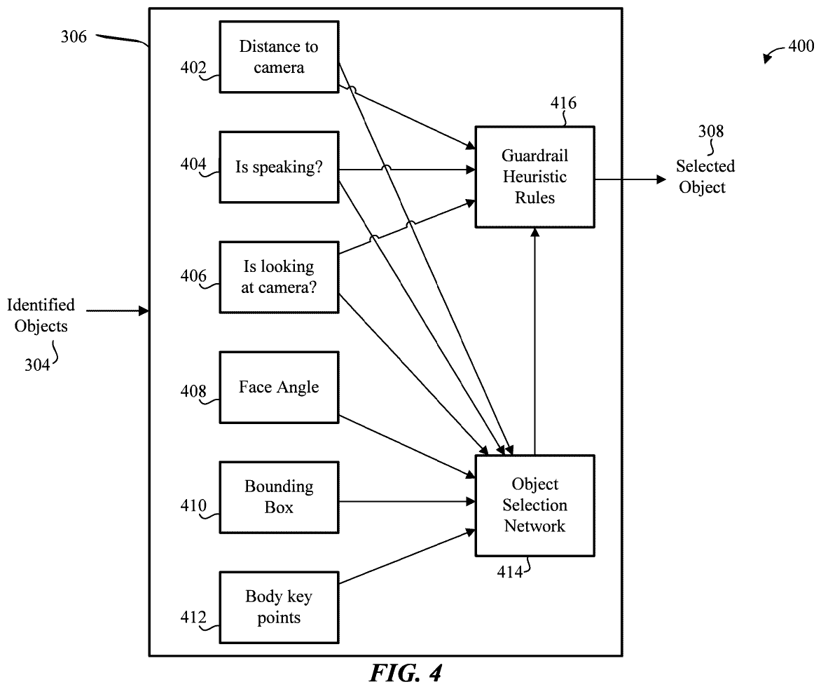

As illustrated in FIG. 3, process 300 also includes object selection 306. Object selection 306 receives identified objects 304. Object selection 306 selects one or more objects (e.g., from identified objects 304) and outputs the one or more objects as selected object 308. It should be recognized that object selection 306 can select multiple objects such that further operations performed in process 300 are with respect to multiple objects rather than a single object. In some embodiments, object selection 306 selects the one or more objects based on the attributes determined by multi object tracker 302. In other embodiments, object selection 306 determines attributes of objects and selects the one or more attributed based on the attributes determined by multi object tracker 302 and/or object selection 306. Additional features and functions of object selection 306 are described below with respect to FIG. 4.

As illustrated in FIG. 3, process 300 also includes object framing 310. In some embodiments, object framing 310 receives selected object 308. Object framing 310 frames media based on a current and/or past state of selected object 308. For example, object framing 310 can frame the media by using gaze, face orientation, body orientation, distance to the one or more cameras, and/or whether one or more people of selected object 308 is speaking or pointing in a particular direction. As an example, when a selected object is Johnny Appleseed and Johnny Appleseed is pointing in the physical environment, object framing 310 can zoom out and/or physically move the one or more cameras to capture Johnny Appleseed and/or an area that Johnny Appleseed is pointing toward. For another example, when selected objects include Johnny Appleseed and Jane Appleseed, object framing 310 can zoom out and/or physically move the one or more cameras to capture both Johnny Appleseed and Jane Appleseed.

FIG. 4 is a block diagram illustrating a process for selecting one or more objects in accordance with some embodiments. FIG. 4 is used to expand on how object selection 306 of FIG. 3 can be performed. As illustrated in FIG. 4, process 400 includes multiple components. Each of the components of process 400 can be performed by the computer system and/or one or more other computer systems different from the computer system.

As illustrated in FIG. 4, process 400 includes object selection network 414. In some embodiments, object selection network 414 is a machine learning system, such as a machine learning model. For example, object selection network 414 can be a supervised learning model (such as a classification model or a regression model including Naïve Bayes, Nearest Neighbor, Discriminant Analysis, Linear Regression, Generalized Linear Model, Gaussian Process, Support Vector Machine, Decision Tree, Ensemble Method, and/or Neural Network) or unsupervised learning model (such as a cluster model including K-Means, K-Medoids, Fuzzy C-Means, Hierarchical, Gaussian Mixture, and/or Hidden Markov Model). In some embodiments, object selection network 414 is trained on media of scenarios and/or different factors. For example, object selection network 414 can be trained on videos of a physical environment with objects that are already selected.

As illustrated in FIG. 4, object selection network 414 receives different inputs (sometimes referred to as features) for selecting one or more objects. Such inputs can be used independently and/or together to select one or more objects. In some embodiments, different inputs are used to select different objects and/or certain inputs are weighted more in selection of certain objects than other inputs.

At FIG. 4, object selection network 414 uses distance to camera 402 to select an object. In some embodiments, distance to camera 402 refers to a determination of whether an object is within a threshold distance (e.g., 0.1 inches to 200 feet) of the one or more cameras. At FIG. 4, object selection network 414 uses is speaking 404 to select an object. In some embodiments, is speaking 404 refers to a determination of whether an object is communicating, such as speaking, gesturing with sign language, and/or performing another mode of communication. At FIG. 4, object selection network 414 uses is looking at camera 406 to select an object. In some embodiments, is looking at camera 406 refers to a determination of whether an object is looking at the one or more cameras. At FIG. 4, object selection network 414 uses face angle 408 of an object. In some embodiments, face angle 408 refers to an orientation of a face of the object. At FIG. 4, object selection network 414 uses bounding box 410 of an object. In some embodiments, bounding box 410 refers to an area around the object. For example, Johnny Appleseed can have a bounding box of a head, torso, and/or legs. At FIG. 4, object selection network 414 uses body key points 412 of an object. In some embodiments, body key points 412 refers to an orientation of a portion of an object. For example, the portion can be in a finger and the orientation be where the finger is pointing.

It should be recognized that object selection network 414 can use additional and/or different inputs than described above. For example, object selection network 414 can use motion of an object, a body pose of an object, a position of an object, a velocity of an object, an acceleration of an object, whether an object is moving, whether an object is stationary, historical information corresponding to an object (including information from a previous iteration of object selection network 414), a gaze angle of an object, a gaze direction of an object, a gallery of media (such as for face recognition to focus on an owner of the computer system), hand tracking, keywords spoken by an object, speech-to-text from speech of an object, and/or user input to identify what object to track and/or what to frame.

In some embodiments, object selection network 414 generates a saliency ranking of objects in the physical environment using the factors described above. A saliency ranking can be a priority of objects to be selected. For example, identified objects that satisfy more of the factors described above can have a higher saliency ranking.

In some embodiments, object selection network 414 includes a memory of previous selected objects and/or identified objects that were not selected. In some embodiments, object selection network 414 stores in memory the saliency ranking of previous identified objects. For example, when the media is a frame of a video, object selection network 414 can have selected objects in previous frames of the video. In this example, object selection network 414 can use the previous saliency ranking of an identified object to determine which object to select. In some embodiments, object selection network 414 increases the saliency ranking of an identified object based on the identified object previously having a high saliency ranking. In some embodiments, object selection network 414 decreases the saliency ranking of an identified object based on the identified object previously having a low saliency ranking. Modifying the saliency ranking of an object based on previous saliency rankings can improve object selection by taking into account previous determinations.

As illustrated in FIG. 4, object selection 306 also includes guardrail heuristic rules 416. In some embodiments, guardrail heuristic rules 416 includes one or more rules to select one or more objects. In some embodiments, guardrail heuristic rules 416 uses (e.g., in part or all of) the same inputs as object selection network 414. In some embodiments, the one or more rules of guardrail heuristic rules 416 includes a portion of the same factors as and/or different factors than object selection network 414. In one illustrative example, the rules of guardrail heuristic rules 416 are the following:
Rule1: If an object is within a threshold distance to the one or more cameras and is looking at the one or more cameras, the object is selected.
Rule 2: If an object is within the threshold distance to the one or more cameras and is speaking, the object is selected.
Rule 3: If an object is looking at the one or more cameras and is speaking, the object is selected.
Rule 4: If an object is not within the threshold distance, not looking at the one or more cameras, and is not speaking, the object is selected.

In some embodiments, the one or more rules of guardrail heuristic rules 416 acts as a “check” on selected objects by object selection network 414. Although the above specific rules are listed above, it should be recognized that additional and/or alternative rules can be used to select an object by guardrail heuristic rules 416.

In some embodiments, the one or more rules of guardrail heuristic rules 416 are hierarchical. For example, each rule of guardrail heuristic rules 416 can be sequentially applied on identified objects (e.g., identified objects 304) until one of the rules is satisfied. In such an example, guardrail heuristic rules 416 can determine if rule 1 is satisfied for any object in identified objects 304. If a first identified object and/or a second identified objects satisfies rule 1, guardrail heuristic rules 416 selects the first identified object and/or the second identified object without determining if rules 2-4 are satisfied. If no object satisfies rule 1, guardrail heuristic rules 416 can determine if rule 2 is satisfied for any object in identified objects 304. In this example, the process can continue until one of the one or more rules is satisfied, ending with rule 4. Although the above describes the one or more rules of guardrail heuristic rules 416 as hierarchical, it should be recognized that the one or more rules of guardrail heuristic rules 416 can be applied simultaneously and/or with each rule applied despite if a previous rule was previously satisfied. For example, guardrail heuristic rules 416 can determine if any rule of rules 1-3 is satisfied for any object in identified objects 304. In this example, if any rule of rules 1-3 is satisfied, guardrail heuristic rules 416 selects the identified object.

At FIG. 4, the one or more rules of guardrail heuristic rules 416 uses three inputs for selecting an object in the physical environment. Stated differently, when applying the one or more rules of guardrail heuristic rules 416, guardrail heuristic rules 416 determines if a rule is satisfied using at least one of the following inputs: distance to camera 402, is speaking 404, and is looking at camera 406, as described above.

In some embodiments, guardrail heuristic rules 416 uses additional and/or alternative inputs. For example, guardrail heuristic rules 416 can uses the additional factors used by object selection network 414 (e.g., face angle 408, bounding box 410, and/or body key points 412 described above). In some embodiments, the one or more rules of guardrail heuristic rules 416 is not the rules listed above but is instead whether at least two of the inputs for guardrail heuristic rules 416 are satisfied for an object. For example, when an object is within a threshold distance to the one or more cameras and looking at the one or more cameras, guardrail heuristic rules 416 selects the object. In another example, when an object is near the one or more cameras and speaking, guardrail heuristic rules 416 selects the object. In another example, when an object is looking at the one or more cameras and is speaking, guardrail heuristic rules 416 selects the object despite whether the object is within the threshold distance from the one or more cameras.

In some embodiments, multiple objects are selected by the one or more rules of guardrail heuristic rules 416. For example, five objects identified in a physical environment can satisfy rule 1. In another example, ten objects in a physical environment can only satisfy rule 4 of guardrail heuristic rules 416. In some embodiments, guardrail heuristic rules 416 outputs the multiple objects as selected people 308. In other embodiments, guardrail heuristic rules 416 uses one or more other factors with respect to selecting from the multiple objects, as described further below.

In some embodiments, guardrail heuristic rules 416 uses the selected objects from object selection network 414 to select from the multiple objects. Stated differently, guardrail heuristic rules 416 uses object selection network 414 to reduce a number of objects selected by the rules of guardrail heuristic rules 416. For example, four objects can satisfy rule 2 of guardrail heuristic rules 416. In such an example, object selection network 414 can have selected two objects of the four objects. In this example, guardrail heuristic rules 416 selects the two objects selected by object selection network 414 and outputs them as selected object 308.

In some embodiments, where rules of guardrail heuristic rules 416 are hierarchical, guardrail heuristic rules 416 uses the objects selected by object selection network 414 to refine selection of the rule that is highest in the hierarchy. For example, two objects can satisfy rule 1 of guardrail heuristic rules 416 and two objects can satisfy rule 2 of guardrail heuristic rules 416. In this example, object selection network 414 can select one of the objects that satisfied rule 1 and both objects that satisfied rule 2. In this example, guardrail heuristic rules 416 outputs only the one object that satisfied rule 1 as identified by object selection network 414. In this example, the objects that satisfied rule 2 were not selected because an object satisfied the higher rule 1 of guardrail heuristic rules 416.

In some embodiments, guardrail heuristic rules 416 selects objects that are altogether different from object selection network 414. For example, guardrail heuristic rules 416 selects two objects that satisfy rule 3 while object selection network 414 selected four objects different from the two selected by guardrail heuristic rules 416. In some embodiments, when guardrail heuristic rules 416 selects different objects from object selection network 414, guardrail heuristic rules 416 causes the memory of object selection network 414 to be reset and outputs the selected objects determined by the one or more rules of guardrail heuristic rules 416 as selected object 308.

In some embodiments, object selection network 414 resets the memory to no longer promote and/or demote objects based on previous iterations. For example, if Johnny Appleseed is selected by object selection network 414 and Jane Appleseed is selected by guardrail heuristic rules 416, the computer system resets the memory of object selection network 414. In this example, Johnny Appleseed may have been promoted in saliency ranking by object selection network 414 over a similar saliency ranking of Jane Appleseed because, previously, Johnny Appleseed had the higher saliency value. In this example, resetting the memory of object selection network 414 removes the bias (e.g., the promotion) afforded to Johnny Appleseed to be selected. Resetting the memory of object selection network 414 ensures previous history of objects in the physical environment do not influence object selection network 414 to select the wrong object. However, maintaining the memory of object selection network 414 when there is no conflict in selected object by guardrail heuristic rules 416 enables the previous history of objects to influence which objects are selected as selected object 308.

In some embodiments, one identified object is selected by guardrail heuristic rules 416. In these embodiments, guardrail heuristic rules 416 outputs the selected object as selected object 308 regardless of and/or not based on selected objects by object selection network 414. In some embodiments, no identified object is selected by guardrail heuristic rules 416 (e.g., there are no identified objects). In such embodiments, guardrail heuristic rules 416 outputs no selected object as selected object 308.

FIG. 5 is a flow diagram illustrating a method (e.g., method 500) for selecting subjects in accordance with some embodiments. Some operations in method 500 are, optionally, combined, the orders of some operations are, optionally, changed, and some operations are, optionally, omitted.

As described below, method 500 provides an intuitive way for selecting subjects. Method 500 reduces the cognitive burden on a user, thereby creating a more efficient human-machine interface. For battery-operated computing devices, enabling a user to interact with such devices faster and more efficiently conserves power and increases the time between battery charges.

In some embodiments, process 500 is performed at a computer system that is in communication (e.g., wired communication and/or wireless communication) with one or more input devices (e.g., a camera, a depth sensor, a microphone, a hardware input mechanism, a rotatable input mechanism, a heart monitor, a temperature sensor, and/or a touch-sensitive surface). In some embodiments, the computer system is a phone, a watch, a tablet, a fitness tracking device, a wearable device, an accessory, a speaker, a light, a head-mounted display (HMD), and/or a personal computing device.

The computer system detects (502), via the one or more input devices, one or more subjects (e.g., objects as described above with respect to FIGS. 3 and 4) in an environment (e.g., a physical environment, space, and/or area) (e.g., via 302).

In response to (504) detecting the one or more subjects (e.g., objects as described above with respect to FIGS. 3 and 4) in the environment, in accordance with a determination that the one or more subjects (e.g., objects as described above with respect to FIGS. 3 and 4) includes a plurality of subjects, that the plurality of subjects satisfy a first set of one or more criteria (e.g., 416) (e.g., a set of one or more heuristic rules), and that a first subject (e.g., a user, a person, an animal, another computer system different from the computer system, a device, and/or an object) of the plurality of subjects is selected via a subject selection model (e.g., 414) (e.g., a neural network), the computer system performs (506) a first operation (e.g., outputting selected people 308, and/or framing the media as described above with respect to FIGS. 3 and 4) (e.g., maintains a field-of-view, physically moves a camera of the computer system, and/or zooms) with respect to the first subject without performing an operation with respect to a second subject (e.g., a user, a person, an animal, another computer system different from the computer system, a device, and/or an object) of the plurality of subjects, wherein the second subject is different from the first subject, and wherein the first set of one or more criteria does not include a criterion based on the subject selection model. In some embodiments, the first set of one or more criteria includes a criterion that is satisfied based on a position, a movement, a hand gesture, a gaze, a location, an orientation, and/or a presence of the one or more subjects. In some embodiments, the first set of one or more criteria includes a criterion that is satisfied when the one or more subjects is speaking, when the one or more subjects is looking at the computer system and/or the one or more input devices, and/or when the one or more subjects is within a predefined distance (e.g., 0-10 feet) of the computer system and/or the one or more input devices.

In response to (504) detecting the one or more subjects in the environment, in accordance with a determination that the one or more subjects (e.g., objects as described above with respect to FIGS. 3 and 4) includes the plurality of subjects, that the plurality of subjects satisfy the first set of one or more criteria (e.g., 416), and that the second subject is selected via the subject selection model (e.g., 414), the computer system performs (508) a second operation (e.g., outputting selected people 308, and/or framing the media as described above with respect to FIGS. 3 and 4) (e.g., maintains a field-of-view, physically moves a camera of the computer system, and/or zooms) with respect to the second subject without performing an operation with respect to the first subject. In some embodiments, the second operation is the same operation as the first operation but with respect to a different subject (e.g., the first operation with respect to the first subject includes maintaining the subject in the field-of-view and the second operation with respect to the second subject includes maintaining the subject in the field-of-view). In some embodiments, the second operation is different from the first operation and with respect to a different subject (e.g., the first operation with respect to the first subject includes physically moving the camera of the computer system to follow the first subject, and the second operation with respect to the second subject includes zooming the camera on at least a portion of the second subject).

In response to (504) detecting the one or more subjects in the environment, in accordance with a determination that the one or more subjects (e.g., objects as described above with respect to FIGS. 3 and 4) includes (and/or is) a third subject (e.g., a single subject) and that the third subject satisfies the first set of one or more criteria (e.g., 416), the computer system performs (510) a third operation (e.g., outputting selected people 308, and/or framing the media as described above with respect to FIGS. 3 and 4) (e.g., maintains a field-of-view, physically moves a camera of the computer system, and/or zooms) with respect to the third subject (e.g., irrespective of a subject selected via the subject selection model). In some embodiments, the third subject is the first subject, the second subject, or another subject different from the first subject and the second subject. In some embodiments, the computer system performs a different operation with respect to the third subject than the first operation and/or the second operation. In some embodiments, the computer system performs the same operation with respect to the third subject as the first operation and/or the second operation.

In some embodiments, the one or more inputs devices includes a camera. In some embodiments, the first set of one or more criteria (e.g., 416) includes a criterion that is satisfied when a determination is made that a subject (e.g., a user, a person, an animal, another computer system different from the computer system, a device, and/or an object) (e.g., the plurality of subjects, the first subject, the second subject, and/or another subject different from the first subject and the second subject) is (and/or within) a first distance (e.g., a predefined distance, such as 0.1 inches to 200 feet) from the camera (and/or the computer system) (e.g., Rules 1-2, as described above with respect to FIG. 4).

In some embodiments, the first set of one or more criteria (e.g., 416) includes a criterion that is satisfied when a determination is made that a subject (e.g., a user, a person, an animal, another computer system different from the computer system, a device, and/or an object) (e.g., the plurality of subjects, the first subject, the second subject, and/or another subject different from the first subject and the second subject) is speaking (e.g., communicating, using sign language, and/or gestures) (and/or was speaking within a predefined period of time) (e.g., Rules 2-3, as described above with respect to FIG. 4). In some embodiments, a predefined period of time is 1-30 seconds.

In some embodiments, the one or more inputs devices includes camera. In some embodiments, the first set of one or more criteria (e.g., 416) includes a criterion that is satisfied when a determination is made that a subject (e.g., a user, a person, an animal, another computer system different from the computer system, a device, and/or an object) (e.g., the plurality of subjects, the first subject, the second subject, and/or another subject different from the first subject and the second subject) is looking at the camera (and/or the computer system) (e.g., Rules 1 and 3, as described above with respect to FIG. 4). In some embodiments, the determination is made that the subject is looking at the second camera when a determination is made that the gaze of the subject is directed to and/or at the camera and/or the computer system.

In some embodiments, the first subject is selected via the subject selection model (e.g., 414) based on a face angle (e.g., 408) (e.g., orientation of face and/or position of face) of the first subject. In some embodiments, the subject selection model selects the first subject based on the face angle of the first subject, such that the first subject is selected when the face angle of the first subject satisfies a set of one or more criteria (e.g., is facing a particular direction) and a face angle of the second subject does not satisfy the set of one or more criteria (e.g., is not facing the particular direction) and that the second subject is selected when the face angle of the second subject satisfies the set of one or more criteria (e.g., is facing the particular direction) and the face angle of the first subject does not satisfy the set of one or more criteria (e.g., is not facing the particular direction). In some embodiments, the first subject is selected via the subject selection model when the face angle of the first subject is facing the computer system and/or the one or more input devices.

In some embodiments, the first subject is selected via the subject selection model (e.g., 414) based on a bounding box (e.g., 410) (e.g., detection area boundary) of the first subject. In some embodiments, the subject selection model selects the first subject based on the bounding box of the first subject, such that the first subject is selected when a predefined amount and/or a predefined percentage of the bounding box of the first subject is within a field of view of the one or more input devices and a predefined amount and/or a predefined percentage of a bounding box of the second subject is not within the field of view of the one or more input devices. In some embodiments, the subject selection model selects the first subject based on the bounding box of the first subject, such that the first subject is selected when more of the bounding box of the first subject is within a field of view of the one or more input devices than a bounding box of the second subject and that the second subject is selected when more of the bounding box of the second subject is within the field of view of the one or more input devices than the bounding box of the second subject. In some embodiments, the subject selection model selects the first subject based on the bounding box of the first subject, such that the first subject is selected when the bounding box of the first subject is within an area of a field of view of the one or more input devices and that the second subject is selected when the bounding box of the second subject is within the area of the field of view of the one or more input devices.

In some embodiments, the first subject is selected via the subject selection model (e.g., 414) based on a body pose (e.g., 412) (e.g., position and/or orientation of one or more portions of the subject) of the first subject. In some embodiments, the subject selection model selects the first subject based on the body pose of the first subject, such that the first subject is selected when the body pose of the first subject satisfies a set of one or more criteria (e.g., is facing and/or appears to be interacting with the computer system) and a body pose of the second subject does not satisfy the set of one or more criteria (e.g., is not facing and/or does not appear to be interacting with the computer system) and that the second subject is selected when the body pose of the second subject satisfies the set of one or more criteria (e.g., is facing and/or appears to be interacting with the computer system) and the body pose of the first subject does not satisfy the set of one or more criteria (e.g., is not facing and/or does not appear to be interacting with the computer system).

In some embodiments, the first subject is selected via the subject selection model (e.g., 414) based on motion (e.g., a movement, a gesture, a change in position, and/or a change in orientation) of the first subject (e.g., as described above with respect to FIG. 4). In some embodiments, the subject selection model selects the first subject based on the motion of the first subject, such that the first subject is selected when the motion of the first subject satisfies a set of one or more criteria (e.g., the motion is above a threshold and/or toward the computer system and/or the one or more input devices) and motion of the second subject does not satisfy the set of one or more criteria (e.g., the motion is not above the threshold and/or not toward the computer system and/or the one or more input devices) and that the second subject is selected when the motion of the second subject satisfies the set of one or more criteria (e.g., the motion is above a threshold and/or toward the computer system and/or the one or more input devices) and the motion of the first subject does not satisfy the set of one or more criteria (e.g., the motion is not above the threshold and/or not toward the computer system and/or the one or more input device).

In some embodiments, the first subject is selected via the subject selection model (e.g., 414) based on a position of the first subject (e.g., as described above with respect to FIG. 4). In some embodiments, the position of the subject is a location, a coordinate, an orientation, and/or a physical position of the first subject. In some embodiments, the subject selection model selects the first subject based on the position of the first subject, such that the first subject is selected when the position of the first subject satisfies a set of one or more criteria (e.g., the position is within a distance of the computer system and/or the one or more input devices) and a position of the second subject does not satisfy the set of one or more criteria (e.g., the position is not within the distance of the computer system and/or the one or more input devices) and that the second subject is selected when the position of the second subject satisfies the set of one or more criteria (e.g., the position is within the distance of the computer system and/or the one or more input devices) and the position of the first subject does not satisfy the set of one or more criteria (e.g., the position is not within the distance of the computer system and/or the one or more input devices).

In some embodiments, the first subject is selected via the subject selection model (e.g., 414) based on an audio input corresponding to the first subject (e.g., as described above with respect to FIG. 4). In some embodiments, the audio input includes a verbal input, a verbal utterance, a sound, an audible request, an audible command, and/or an audible statement. In some embodiments, the subject selection model selects the first subject based on the audio input of the first subject, such that the first subject is selected when the first subject is speaking and/or speaking toward the computer system and/or the one or more input devices and the second subject is not speaking and/or not speaking toward the computer system and/or the one or more input devices and that the second subject is selected when the second subject is speaking and/or speaking toward the computer system and/or the one or more input devices and the first subject is not speaking and/or not speaking toward the computer system and/or the one or more input devices.

In some embodiments, in response to detecting the one or more subjects (e.g., objects as described above with respect to FIGS. 3 and 4) in the environment and in accordance with a determination that the one or more subjects includes the plurality of subjects, that a third subject of the plurality of subjects and a fourth subject, different from the third subject, of the plurality of subjects is selected via the subject selection model (e.g., 414), the computer system performs a fourth operation (e.g., outputting selected people 308, and/or framing the media as described above with respect to FIGS. 3 and 4) (e.g., maintains a field-of-view, physically moves a camera of the computer system, and/or zooms) with respect to the third subject and the fourth subject. In some embodiments, the fourth subject is the first subject, the second subject, or another subject different from the first subject, the second subject, and the third subject. In some embodiments, the computer system performs a different operation with respect to the third subject and the fourth subject than the first operation, the second operation, and/or the third operation. In some embodiments, the computer system performs the same operation with respect to the third subject and the fourth subject as the first operation, the second operation, and/or the third operation.

In some embodiments, in response to detecting the one or more subjects (e.g., objects as described above with respect to FIGS. 3 and 4) in the environment and in accordance with a determination that the one or more subjects includes the plurality of subjects, that the plurality of subjects satisfy a second set of one or more criteria (e.g., 416) (e.g., the first set of one or more criteria include a criterion that is satisfied when the subject moves and the second set of one or more criteria include a criterion that is satisfied when the subject is at a location) different from the first set of one or more criteria, that the one or more subjects fail to satisfy the first set of one or more criteria, and that a fifth subject is selected via the subject selection model, the computer system performs a fifth operation (e.g., outputting selected people 308, and/or framing the media as described above with respect to FIGS. 3 and 4) with respect to the fifth subject. In some embodiments, the fifth subject is the first subject, the second subject, the third subject, or another subject different from the first subject, the second subject, and the third subject. In some embodiments, the computer system performs a different operation with respect to the fifth subject than the first operation, the second operation, and/or the third operation. In some embodiments, the computer system performs the same operation with respect to the fifth subject as the first operation, the second operation, and/or the third operation.

In some embodiments, in response to detecting the one or more subjects (e.g., objects as described above with respect to FIGS. 3 and 4) in the environment and in accordance with a determination that the one or more subjects includes the third subject (e.g., a single subject) and that the sixth subject satisfies a third set of one or more criteria (e.g., 416) (e.g., a set of one or more heuristic rules) different from the first set of one or more criteria (e.g., the first set of one or more criteria include a criterion that is satisfied when the subject moves and the third set of one or more criteria include a criterion that is satisfied when the subject is at a location), the computer system performs a sixth operation (e.g., outputting selected people 308, and/or framing the media as described above with respect to FIGS. 3 and 4), different from the third operation, with respect to the third subject. In some embodiments, the computer system performs a different operation with respect to the third subject than the first operation and/or the second operation. In some embodiments, the computer system performs the same operation with respect to the third subject as the first operation and/or the second operation.

In some embodiments, the one or more input devices includes a camera. In some embodiments, performing an operation (e.g., outputting selected people 308, and/or framing the media as described above with respect to FIGS. 3 and 4) with respect to a subject (e.g., the first operation, the second operation, the third operation, and/or another operation different from the first operation and the second operation) includes maintaining the subject in a field-of-view of the camera (e.g., as described above with respect to FIGS. 3 and 4). In some embodiments, maintaining the subject in the field-of-view of the camera includes moving (e.g., pan, tilt, and/or change physical position) the third camera and/or zooming the camera to maintain the subject in the field-of-view of the third camera.

In some embodiments, the one or more input devices includes a camera. In some embodiments, performing an operation (e.g., outputting selected people 308, and/or framing the media as described above with respect to FIGS. 3 and 4) with respect to a subject (e.g., the first operation, the second operation, the third operation, and/or another operation different from the first operation and the second operation) includes moving the camera to frame the subject in a particular manner (e.g., framing as described above with respect to FIGS. 3 and 4). In some embodiments, is the particular manner includes a composure, a framing, a size, and/or an angle of the subject in a field-of-view of the camera.

In some embodiments, the first set of one or more criteria (e.g., 416) is (and/or includes) a first set of one or more heuristics. In some embodiments, the subject selection model (e.g., 414) is (and/or includes) a neural network. In some embodiments, the first set of one or more heuristic rules is based on a position, a movement, a hand gesture, a gaze, a location, an orientation, and/or a presence of the one or more subjects. In some embodiments, the first set of one or more heuristic rules is based on when the one or more subjects is speaking, when the one or more subjects is looking at the computer system and/or the one or more input devices, and/or when the one or more subjects is within a predefined distance (e.g., 0-10 feet) of the computer system and/or the one or more input devices.

Note that details of the processes described above with respect to method 500 (e.g., FIG. 5) are also applicable in an analogous manner to other methods described herein. For example, method 600 optionally includes one or more of the characteristics of the various methods described above with reference to method 500. For example, resetting memory of a subject selection model at method 600 can occur before detecting the one or more subjects in the environment at method 500. For brevity, these details are not repeated herein.

FIG. 6 is a flow diagram illustrating a method (e.g., method 600) for resetting memory of a subject selection model in accordance with some embodiments. Some operations in method 600 are, optionally, combined, the orders of some operations are, optionally, changed, and some operations are, optionally, omitted.

As described below, method 600 provides an intuitive way for resetting memory of a subject selection model. Method 600 reduces the cognitive burden on a user, thereby creating a more efficient human-machine interface. For battery-operated computing devices, enabling a user to interact with such devices faster and more efficiently conserves power and increases the time between battery charges.

In some embodiments, process 600 is performed at a computer system. In some embodiments, the computer system is a phone, a watch, a tablet, a fitness tracking device, a wearable device, an accessory, a speaker, a light, a head-mounted display (HMD), and/or a personal computing device.

The computer system receives (602) (and/or detects, identifies, determines, and/or selects), via (and/or from) a subject selection model (e.g., 414) (e.g., as described above with respect to method 500), an identification of a first subject (e.g., a selected object selected by 414 with respect to FIG. 4) (e.g., a user, a person, an animal, another computer system different from the computer system, a device, and/or an object). In some embodiments, the identification of the first subject is received by a first process of the computer system from a second process of the computer system. In some embodiments, the identification of the first subject is received by a first process of the computer system from a first process of another computer system different from and in communication with the computer system. In some embodiments, the first subject is in an environment (e.g., a physical environment, space, and/or area). In some embodiments, the computer system is in the environment.

The computer system receives (604) (and/or detects, identifies, determines, and/or selects), via a first set of one or more heuristics (e.g., 416) (e.g., as described above with respect to the first set of one or more criteria of method 500), an identification of a second subject (e.g., a selected object selected by 416 with respect to FIG. 4) (e.g., a user, a person, an animal, another computer system different from the computer system, a device, and/or an object).

After (606) receiving the identification of the first subject (e.g., a selected object selected by 414 with respect to FIG. 4) and the identification of the second subject (e.g., a selected object selected by 416 with respect to FIG. 4) (and/or in response to receiving the identification of the first subject or the identification of the second subject), in accordance with a determination that the first subject (e.g., a selected object selected by 414 with respect to FIG. 4) is different from the second subject (e.g., a selected object selected by 416 with respect to FIG. 4) (e.g., that the second subject is different from the first subject), the computer system resets (608) (e.g., clears, deletes, removes, erases, and/or wipes) memory (e.g., clear all cached facial data, reset motion detection parameters, erase thermal signature profiles, and/or wipe size and/or shape settings) of the subject selection model (e.g., as described above with respect to FIG. 4).

After (606) receiving the identification of the first subject and the identification of the second subject, in accordance with a determination that the first subject (e.g., a selected object selected by 414 with respect to FIG. 4) is the second subject (e.g., a selected object selected by 416 with respect to FIG. 4) (e.g., that the second subject is the first subject), the computer system forgoes (610) resetting (and/or maintains) the memory of the subject selection model (e.g., 414) (e.g., as described above with respect to FIG. 4).

In some embodiments, after resetting the memory of the subject selection model (e.g., 414), the computer system receives (and/or detects, identifies, determines, and/or selects), via the subject selection model, an identification of a third subject (e.g., a selected object selected by 414 with respect to FIG. 4) (e.g., a user, a person, an animal, another computer system different from the computer system, a device, and/or an object). In some embodiments, the third subject is different from the first subject and/or the second subject. In some embodiments, the third subject is the first subject and/or the second subject. In some embodiments, the computer system receives (and/or detects, identifies, determines, and/or selects), via a second set of one or more heuristics (e.g., 416) (e.g., as described above with respect to the first set of one or more criteria of method 500) different from the first set of one or more heuristics, an identification of a fourth subject (e.g., a selected object selected by 416 with respect to FIG. 4) (e.g., a user, a person, an animal, another computer system different from the computer system, a device, and/or an object). In some embodiments, the second set of one or more heuristics includes one or more criteria that is different from the first set of one or more heuristic rules. In some embodiments, after receiving the identification of the third subject (e.g., a selected object selected by 414 with respect to FIG. 4) and the identification of the fourth subject (e.g., a selected object selected by 416 with respect to FIG. 4) (and/or in response to receiving the identification of the third subject or the identification of the fourth subject), in accordance with a determination that the third subject (e.g., a selected object selected by 414 with respect to FIG. 4) is different from the fourth subject (e.g., a selected object selected by 416 with respect to FIG. 4) (e.g., that the third subject is different from the fourth subject), the computer system resets the memory of the subject selection model (e.g., as described above with respect to FIG. 4). In some embodiments, after receiving the identification of the third subject and the identification of the fourth subject, in accordance with a determination that the third subject (e.g., a selected object selected by 414 with respect to FIG. 4) is the fourth subject (e.g., a selected object selected by 416 with respect to FIG. 4) (e.g., that the fourth subject is the third subject), the computer system forgoes resetting (and/or maintains) the memory of the subject selection model (e.g., 414) (e.g., as described above with respect to FIG. 4).

In some embodiments, after receiving the identification of the first subject (e.g., a selected object selected by 414 with respect to FIG. 4) and the identification of the second subject (e.g., a selected object selected by 416 with respect to FIG. 4) (and/or in response to receiving the identification of the first subject or the identification of the second subject) and in accordance with the determination that the first subject is different from the second subject (and/or in conjunction with (e.g., before, while, after, and/or in response to) resetting the memory of the subject selection model), the computer system performs a first operation (e.g., outputting selected people 308, and/or framing the media as described above with respect to FIGS. 3 and 4) (e.g., maintains a field-of-view, physically moves a camera of the computer system, and/or zooms) with respect to the second subject without performing an operation with respect to the first subject.

In some embodiments, after receiving the identification of the first subject (e.g., a selected object selected by 414 with respect to FIG. 4) and the identification of the second subject (e.g., a selected object selected by 416 with respect to FIG. 4) (and/or in response to receiving the identification of the first subject or the identification of the second subject) and in accordance with the determination that the first subject is the second subject (and/or in conjunction with (e.g., before, while, after, and/or in response to) resetting the memory of the subject selection model), the computer system performs a second operation (e.g., outputting selected people 308, and/or framing the media as described above with respect to FIGS. 3 and 4) (e.g., maintains a field-of-view, physically moves a camera of the computer system, and/or zooms) with respect to the first subject (and/or without performing an operation with respect to the second subject).

In some embodiments, after forgoing resetting (and/or after maintains) the memory of the subject selection model (e.g., 414), the computer system receives (and/or detects, identifies, determines, and/or selects), via (and/or from) the subject selection model (e.g., as described above with respect to method 500), an identification of a fifth subject (e.g., a selected object selected by 414 with respect to FIG. 4) (e.g., a user, a person, an animal, another computer system different from the computer system, a device, and/or an object). In some embodiments, the fifth subject is different from the first subject and/or the second subject. In some embodiments, the fifth subject is the same as the first subject and/or the second subject. In some embodiments, the computer system receives (and/or detects, identifies, determines, and/or selects), via the first set of one or more heuristics (e.g., 416), an identification of a sixth subject (e.g., a selected object selected by 416 with respect to FIG. 4) (e.g., a user, a person, an animal, another computer system different from the computer system, a device, and/or an object). In some embodiments, the sixth subject is different from the first subject and/or the second subject. In some embodiments, the sixth subject is the same as the first subject and/or the second subject. In some embodiments, after receiving the identification of the fifth subject (e.g., a selected object selected by 414 with respect to FIG. 4) and the identification of the sixth subject (e.g., a selected object selected by 416 with respect to FIG. 4), in accordance with a determination that the fifth subject (e.g., a selected object selected by 414 with respect to FIG. 4) is different from the sixth subject (e.g., that the sixth subject is different from the fifth subject) (e.g., a selected object selected by 416 with respect to FIG. 4), the computer system resets the memory of the subject selection model (e.g., 414) (e.g., as described above with respect to FIG. 4). In some embodiments, after receiving the identification of the fifth subject and the identification of the sixth subject, in accordance with a determination that the fifth subject (e.g., a selected object selected by 414 with respect to FIG. 4) is the same as the sixth subject (e.g., a selected object selected by 416 with respect to FIG. 4) (e.g., that the sixth subject is the fifth subject), the computer system forgoes resetting (and/or maintains) the memory of the subject selection model (e.g., 414) (e.g., as described above with respect to FIG. 4).

In some embodiments, the memory of the subject selection model (e.g., 414) includes (and/or is) a priority (e.g., ranking and/or order) of the first subject (e.g., a selected object selected by 414 with respect to FIG. 4) and a priority of the second subject (e.g., a selected object selected by 416 with respect to FIG. 4) (and/or additional subjects). In some embodiments, the priority of the first subject is relative to the priority of the second subject. In some embodiments, the priority of the first subject and the priority of the second subject is affected by previous iterations of the subject selection model as long as the memory of the subject selection model has not been reset.

In some embodiments, the memory of the subject selection model (e.g., 414) includes (and/or is) a relevancy score (e.g., an amount of relevance to a current task and/or operation of the computer system) of a subject (e.g., in the environment) (e.g., as described above with respect to FIG. 4). In some embodiments, the relevancy score is affected by previous iterations of the subject selection model as long as the memory of the subject selection model has not been reset.

In some embodiments, the subject selection model (e.g., 414) is (and/or includes) a neural network.

Note that details of the processes described above with respect to method 600 (e.g., FIG. 6) are also applicable in an analogous manner to the methods described herein. For example, method 500 optionally includes one or more of the characteristics of the various methods described herein with reference to method 600. For example, performing a first operation with respect to a first subject of method 500 can be sent and received as an identification of a first subject of method 600. For brevity, these details are not repeated herein.

In some embodiments, one or more of processes 500 and 600 (FIGS. 5 and 6) is performed at a first computer system (as described herein) via a system process (e.g., an operating system process) that is different from one or more applications executing and/or installed on the first computer system.

In some embodiments, one or more of processes 500 and 600 (FIGS. 5 and 6) is performed at a first computer system (as described herein) by an application that is different from a system process. In some embodiments, the instructions of the application, when executed, control the first computer system to perform one or more of processes 500 and 600 (FIGS. 5 and 6) by calling an application programming interface (API) provided by the system process. In some embodiments, the application performs at least a portion of one or more of processes 500 and 600 (FIGS. 5 and 6) without calling the API. In some embodiments, the application can be any suitable type of application, including, for example, one or more of: a browser application, a super-app that functions as an application execution environment for plug-ins, widgets or other applications, a fitness application, a health application, a digital payments application, a media application, a social network application, a messaging application, and/or a maps application. In some embodiments, the application is an application that is pre-installed on the first computer system at purchase (e.g., a first party application). In other embodiments, the application is an application that is provided to the first computer system via an operating system update file (e.g., a first party application). In other embodiments, the application is an application that is provided via an application store. In some implementations, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform one or more of processes 500 and 600 (FIGS. 5 and 6) by calling an application programming interface (API) provided by the system process using one or more parameters. In some embodiments, exemplary APIs provided by the system process include one or more of: a Pairing API (e.g., for establishing secure connection, e.g., with an accessory), a Device detection API (e.g., for locating nearby devices, e.g., Apple TVs, other iPhones), a UIKit API (e.g., for generating user interfaces), a Location Detection API, a FindMy API, a Maps API, a Health Sensor API, a Sensor API, a Messaging API, a Push Notification API, a Streaming API, a collaboration API, a video conferencing API (e.g., FaceTime/SharePlay API), a web browser API (e.g., WebKit API), a CarPlay API, a Networking API, a WiFi API, a Bluetooth API, an NFC API, a UWB API, a Fitness API, a HomeKit API, NameDrop API, Photos API, Camera API, and/or an Image Processing API. In some embodiments, at least one API is a software module (e.g., a collection of computer-readable instructions) that provides an interface that allows a different module (e.g., API calling module) to access and use one or more functions, processes, procedures, data structures, classes, and/or other services provided by an OS implementation module of the system process. The API can define one or more parameters that are passed between the API calling module and the OS implementation module. The OS implementation module is an operating system software module (e.g., a collection of computer-readable instructions) that is constructed to perform an operation in response to receiving an API call via the API. In some embodiments, the OS implementation module is constructed to provide an API response (via the API) as a result of processing an API call.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the techniques and their practical applications. Others skilled in the art are thereby enabled to best utilize the techniques and various examples with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve selection of objects. The present disclosure contemplates that in some instances, this gathered data can include personal information data that uniquely identifies or can be used to contact or locate a specific person. Such personal information data can include photos, videos, proximity, location-based data, or any other identifying information.

The present disclosure recognizes that the use of such personal information data, in the present technology, can be used to the benefit of users. For example, the personal information data can be used to identify and/or select an object. Accordingly, use of such personal information data enables better object identification and selection. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of image capture, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, media can be captured based on non-personal information data (e.g., a public profile and/or publicly posted media) or media captured by the one or more cameras.

What is claimed is:

1. A method, comprising:
at a computer system that is in communication with one or more input devices:
detecting, via the one or more input devices, one or more subjects in an environment; and
in response to detecting the one or more subjects in the environment:
in accordance with a determination that the one or more subjects includes a plurality of subjects, that the plurality of subjects satisfy a first set of one or more criteria, and that a first subject of the plurality of subjects is selected via a subject selection model, performing a first operation with respect to the first subject without performing an operation with respect to a second subject of the plurality of subjects, wherein the second subject is different from the first subject, and wherein the first set of one or more criteria does not include a criterion based on the subject selection model;
in accordance with a determination that the one or more subjects includes the plurality of subjects, that the plurality of subjects satisfy the first set of one or more criteria, and that the second subject is selected via the subject selection model, performing a second operation with respect to the second subject without performing an operation with respect to the first subject; and
in accordance with a determination that the one or more subjects includes a third subject and that the third subject satisfies the first set of one or more criteria, performing a third operation with respect to the third subject.

2. The method of claim 1, wherein the one or more inputs devices includes a camera, and wherein the first set of one or more criteria includes a criterion that is satisfied when a determination is made that a subject is a first distance from the camera.

3. The method of claim 1, wherein the first set of one or more criteria includes a criterion that is satisfied when a determination is made that a subject is speaking. In some embodiments, a predefined period of time is 1-30 seconds.

4. The method of claim 1, wherein the one or more inputs devices includes camera, and wherein the first set of one or more criteria includes a criterion that is satisfied when a determination is made that a subject is looking at the camera.

5. The method of claim 1, wherein the first subject is selected via the subject selection model based on a face angle of the first subject.

6. The method of claim 1, wherein the first subject is selected via the subject selection model based on a bounding box of the first subject.

7. The method of claim 1, wherein the first subject is selected via the subject selection model based on a body pose of the first subject.

8. The method of claim 1, wherein the first subject is selected via the subject selection model based on motion of the first subject.

9. The method of claim 1, wherein the first subject is selected via the subject selection model based on a position of the first subject.

10. The method of claim 1, wherein the first subject is selected via the subject selection model based on an audio input corresponding to the first subject.

11. The method of claim 1, further comprising:
in response to detecting the one or more subjects in the environment and in accordance with a determination that the one or more subjects includes the plurality of subjects, that a third subject of the plurality of subjects and a fourth subject, different from the third subject, of the plurality of subjects is selected via the subject selection model, performing a fourth operation with respect to the third subject and the fourth subject.

12. The method of claim 1, further comprising:
in response to detecting the one or more subjects in the environment and in accordance with a determination that the one or more subjects includes the plurality of subjects, that the plurality of subjects satisfy a second set of one or more criteria different from the first set of one or more criteria, that the one or more subjects fail to satisfy the first set of one or more criteria, and that a fifth subject is selected via the subject selection model, performing a fifth operation with respect to the fifth subject.

13. The method of claim 1, further comprising:
in response to detecting the one or more subjects in the environment and in accordance with a determination that the one or more subjects includes the third subject and that the sixth subject satisfies a third set of one or more criteria different from the first set of one or more criteria, performing a sixth operation, different from the third operation, with respect to the third subject.

14. The method of claim 1, wherein the one or more input devices includes a camera, and wherein performing an operation with respect to a subject includes maintaining the subject in a field-of-view of the camera.

15. The method of claim 1, wherein the one or more input devices includes a camera, and wherein performing an operation with respect to a subject includes moving the camera to frame the subject in a particular manner.

16. The method of claim 1, wherein the first set of one or more criteria is a first set of one or more heuristics, and wherein the subject selection model is a neural network.

17. A non-transitory computer-readable storage medium storing one or more programs configured to be executed by one or more processors of a computer system that is in communication with one or more input devices, the one or more programs including instructions for:
detecting, via the one or more input devices, one or more subjects in an environment; and
in response to detecting the one or more subjects in the environment:
in accordance with a determination that the one or more subjects includes a plurality of subjects, that the plurality of subjects satisfy a first set of one or more criteria, and that a first subject of the plurality of subjects is selected via a subject selection model, performing a first operation with respect to the first subject without performing an operation with respect to a second subject of the plurality of subjects, wherein the second subject is different from the first subject, and wherein the first set of one or more criteria does not include a criterion based on the subject selection model;
in accordance with a determination that the one or more subjects includes the plurality of subjects, that the plurality of subjects satisfy the first set of one or more criteria, and that the second subject is selected via the subject selection model, performing a second operation with respect to the second subject without performing an operation with respect to the first subject; and
in accordance with a determination that the one or more subjects includes a third subject and that the third subject satisfies the first set of one or more criteria, performing a third operation with respect to the third subject.

18. A computer system configured to communicate with one or more input devices, comprising:
one or more processors; and
memory storing one or more programs configured to be executed by the one or more processors, the one or more programs including instructions for:
detecting, via the one or more input devices, one or more subjects in an environment; and
in response to detecting the one or more subjects in the environment:
in accordance with a determination that the one or more subjects includes a plurality of subjects, that the plurality of subjects satisfy a first set of one or more criteria, and that a first subject of the plurality of subjects is selected via a subject selection model, performing a first operation with respect to the first subject without performing an operation with respect to a second subject of the plurality of subjects, wherein the second subject is different from the first subject, and wherein the first set of one or more criteria does not include a criterion based on the subject selection model;
in accordance with a determination that the one or more subjects includes the plurality of subjects, that the plurality of subjects satisfy the first set of one or more criteria, and that the second subject is selected via the subject selection model, performing a second operation with respect to the second subject without performing an operation with respect to the first subject; and
in accordance with a determination that the one or more subjects includes a third subject and that the third subject satisfies the first set of one or more criteria, performing a third operation with respect to the third subject.
